(19) United States
(12) Patent Application Publication
(10) Pub. No.: US 2005/0093356 A1
(43) Pub. Date: May 5, 2005

(54) Wheeled chair having a clothes hanger

(76) Inventor: Da Dun Liu, Taipei (TW)

Correspondence Address: Keith Kline;PRO-TECHTOR INTERNATIONAL SERVICES, 20775 Norada Court, Saratoga, CA, 95070-3018, US

(21) Appl. No.: 10/726,864

(22) Filed: Dec. 2, 2003

(30) Foreign Application Priority Data
Oct. 31, 2003 (TW) 20032010204.9

(51) Int. Cl. B60N 2/02

(52) U.S. Cl. 297/353

(57) ABSTRACT

A wheeled chair having a clothes hanger comprises a chair back, a chair seat and a stand. The chair back is connected to the chair seat using an L-shaped fixing frame, and the stand is connected to the chair seat through a tubular axle. The rear side of the chair back is further provided with a height-adjusting device, a cushion device and a clothes hanger for hanging clothes and adjusting the height of the hanger. The cushion device facilitates upward motions of the hanger by pulling upward an adjusting frame of the height-adjusting device. A tendon of a resilient part is pressed to depart indentations of the adjusting frame from blocks on the chair back so that the hanger can move downward. Further, multiple cushioning measures are utilized to assure operation safety of adjusting the hanger's height.

### FIELD OF INVENTION

The present invention relates to wheeled chairs having a clothes hanger, more particularly to a wheeled chair having a height-adjustable clothes hanger.

### DESCRIPTION OF PRIOR ART

Referring to FIG. 1, the wheeled chair having a clothes hanger according to ROC patent number 01259987.5 is to provide a hanger device on the a chair back of a chair so that clothes hanged on a chair back will not fall off or wrinkle up. The hanger body comprises an arced transverse bar, a bar mount for locking the transverse bar and a height-adjustable beam to form a T-shaped structure. The invention is disadvantageous in that the bar mount is so short that the transverse bar thus supported is easy to vibrate, causing the clothes hanged to fall off. Another disadvantage of the conventional wheeled chair having a clothes hanger is that height-adjusting rod does not have any cushioning indentations or any other cushioning measures. To rise the clothes hanger, one hand holds the hanger mount and the other hand pulls the hanger up to a desired height, and a tenon tongue or a screw is used to lock the hanger, which is inconvenient to operate. Since there are not any cushioning indentations, the hanger may drop to the lowest height and hurt a user's hand. It is a further disadvantage of the wheeled chair having a clothes hanger of the prior art that a user may pull the hanger too much that the hanger falls off the chair. And the hanger body is not provided with a handle to protect the hand of a user. Since the adjusting rod is attached to the chair back with only one support point, it is thus structurally weak and may breakdown when the person sitting on moves wildly. The structural weakness is further underscored by not having a groove formed on the chair back to house the hanger body. The lack of such a groove forces the hanger body to bulge outward on the chair back and to experience larger stress.

### SUMMARY OF THE INVENTION

Accordingly, the first objective of the present invention is to provide a wheeled chair having a clothes hanger, wherein the adjusting frame is U-shaped and therefore provides an enlarged supporting area, resulting in more stable attachment of the clothes hanger with the chair back. The hanger thus formed is more convenient to pull and will not break away from the chair due to an improper sitting configuration. A plurality of cushioning indentations along the adjusting frame produces a cushioning effect as the hanger changes height, and a plurality of pull resistant indentations prevent the separation of the adjusting frame from chair back.

The second objective of the present invention is to provide a wheeled chair having a clothes hanger, wherein a butterfly cushioning plate and a pull resistant block are mounted on the L-shaped fixing frame under the retaining bases thereon, for restricting the descending speed of the U-shaped adjusting frame and for engaging with the stopping indentations on the adjusting frame. The adjusting frame therefore cannot be pulled any further after attaining a predetermined height. The third objective of the present invention is to provide a wheeled chair having a clothes hanger, wherein an anti-slip sleeve is installed within each of the retaining bases attached on the rear side of the chair back,.so that the vertical motion of the U-shaped adjusting frame can be gentle and steady.

The fourth objective of the present invention is to provide a wheeled chair having a clothes hanger, wherein a receptacle is added to the rear side of the chair back for housing a spring and a pressing piece. A cover with a through hole is screw-mounted onto the receptacle, leaving a tenon tongue of the pressing piece extending outwardly from the through hole. The two arms of the adjusting frame are inserted through the retaining bases on the L-shaped fixing frame into the holes on the butterfly cushioning plate. The tenon tongue of the cushion device engages with a pair of cushioning indentations respectively on two arms of the adjusting frame, so that the vertical movement of the adjusting frame is properly controlled.

The fifth objective of the present invention is to provide an elongated transverse bar mount, the length of which extending to about half of the arced transverse bar. A transverse bar thus mounted is more stable, and its vibrations due to the movements of the sitter are largely reduced. A handle is added to the pull portion of the hanger body to assure a user's safety.

The sixth objective of the present invention is to provide a hanger groove on the chair back so that, when the hanger body is retracted, it can be received within hanger groove, making the chair back look smooth.

Compared with the wheeled chair having a clothes hanger of the prior art, the present invention utilizes a U-shaped frame to reinforce the support of the hanger device on a chair back so that the hanger is more stable. The U-shaped adjusting frame is provided with a plurality of cushioning indentations, and the vertical section of the L-shaped fixing frame is attached with a butterfly cushioning plate and a pull resistant block. These mechanisms are for controlling descending speed of the hanger to avoid abrupt collisions between the parts. Two anti-slip sleeves within the retaining bases that hold the frame even better stabilize the vertical motion of the adjusting frame. The lower portion of the adjusting frame is further provided with pull resistant indentations and stopping indentations, which prevents the frame from being pulled out of the retaining bases after the pull resistant block is locked in those indentations. A cushion device, composed of a receptacle housing a spring and a pressing piece and a cover on which a hole is formed to allow a tenon tongue to extend outwardly, works with the U-shaped adjusting frame to facilitate a convenient height-adjustable hanger. To move the adjusting frame upward, the adjusting frame is pulled upward to a predetermined position where a pair of cushioning indentations is engaged with the pressing piece as ejected by the spring, achieving a stable configuration. To move the adjusting frame downward, a button on the tip of the tenon tongue of the pressing piece extending from the chair back is pressed, so as to release the cushioning indentations of the adjusting frame from the restriction as applied by the pressing piece. The adjusting frame is then pushed downward to a predetermined position where a pair of cushioning indentations is engaged with the pressing piece ejected by the spring, achieving a stable configuration. The present invention provides an elongated transverse bar mount, having a length about half of the arced transverse bar. A transverse bar thus mounted is more stable, and its vibrations due to the movements of the sitter are largely reduced. The present invention provides a hanger groove on the chair back so that, when the hanger body is retracted, it can be received within hanger groove, making the chair back look smooth.

The various objects and advantages of the present invention will be more readily understood from the following detailed description when read in conjunction with the appended drawing.

### BRIEF DESCRIPTION OF THE DRAWINGS

FIG. 1 is a perspective 3-D view of major parts of the present invention.

FIG. 1A is a perspective view of a preferred embodiment of the U-shaped adjusting frame according to the present invention.

FIG. 1B is a perspective view of another preferred embodiment of the U-shaped adjusting frame according to the present invention.

FIG. 2 is a perspective view of major parts of the present invention mounted within the back of a wheeled chair, with the back shell removed.

FIG. 3 is a lateral cross-sectional view of the combination of the adjusting frame moving upward, with the back shell removed.

FIG. 4 is a lateral cross-sectional view of the combination of the adjusting frame moving downward, with the back shell removed.

FIG. 5 is a perspective view of a wheeled chair having a clothes hanger according to the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

The various objects and advantages of the present invention will be more readily understood from the following detailed description of preferred embodiments, when read in conjunction with the appended drawings.

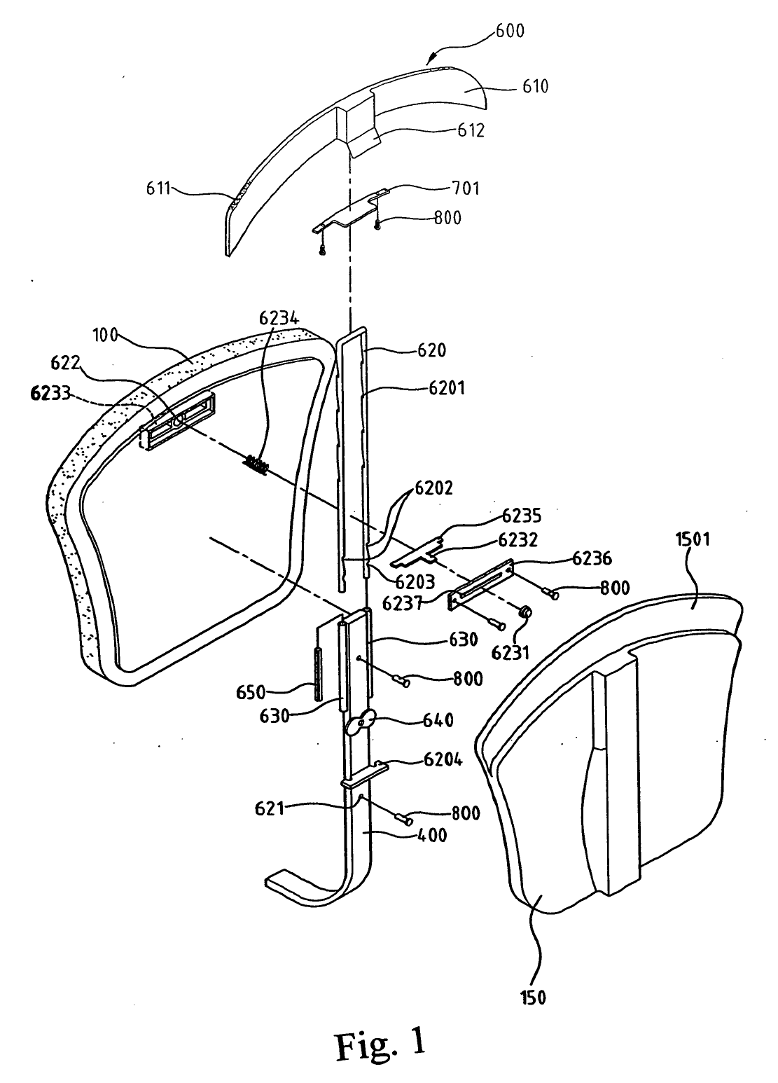

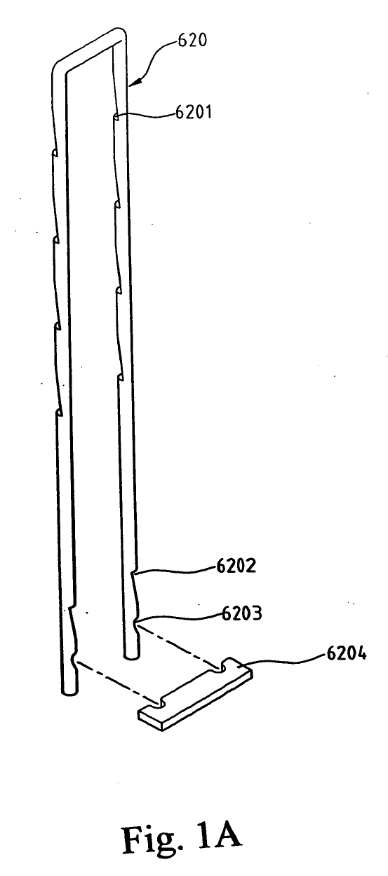

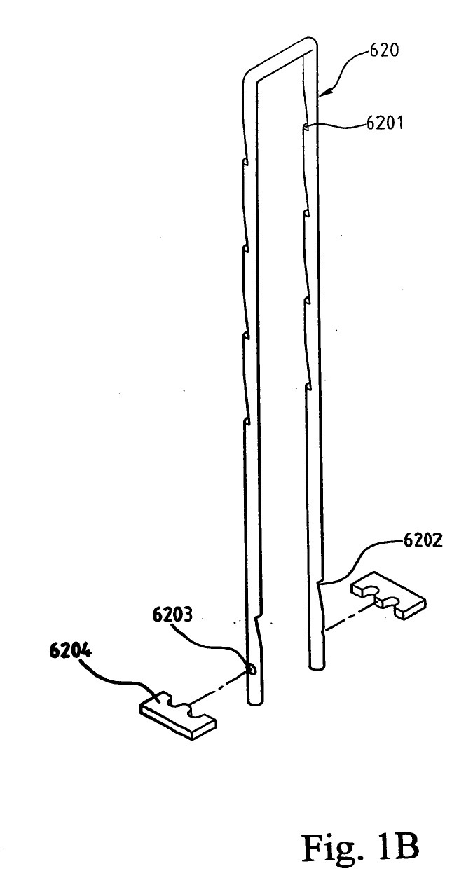

Referring to FIG. 1 and 1A, the clothes hanger 600 is composed of a hanger body and a fixing frame 400 for supporting the hanger body. The hanger body further comprises an arced transverse bar 610 and a transverse bar mount 701, and the transverse bar mount 701 is lock mounted on an adjusting frame 620 to form a T-shaped configuration. The fixing frame 400 is composed of a pair of retaining bases 630, a cushion device 623 and a cushioning butterfly plate 640. The cushion device 623 is housed in a receptacle 622 on the rear side of the chair back 100 for housing a spring 6234 and a pressing piece 6235. A cover 6236 is provided with a through hole 6237 for letting a tenon tongue 6232 of the pressing piece 6235 go through. The cover 6236 is attached onto the receptacle 622 by two screws 800 respectively on two lateral sides. The tip of the tenon tongue 6232 is provided with a button 6231. The retaining bases 630 are hollow bodies each having a hole on the top end for receiving an arm of the U-shaped adjusting frame 620, so that the adjusting frame 620 can move vertically along the retaining bases 630. Each of the retaining bases 630 is further provided with an anti-slip sleeve 650 to assure steady movement of the adjusting frame 620. Each of the arms of the adjusting frame 620 is provided with a plurality of cushioning indentations 6201 in the upper portion and a stopping indentation 6202 in the lower portion. Near the lower end of each arm there is a pull resistant indentation 6203. Those indentations are for cushioning and retaining the hanger body when it is moving. A cushioning butterfly plate 640 and a pull resistant block 6204 are mounted on the fixing frame 400 under the retaining bases 630, for restricting the speed of the adjusting frame 620 so as to avoid shocks. The pull resistant block 6204 engages with the stopping indentations 6202 and the pull resistant indentations 6203 on each of the arms of the adjusting frame 620 to limit the maximum height of the adjusting frame 620. When the adjusting frame 620 is pulled up to a predetermined maximum height, the pull resistant block 6204 engages with the pull resistant indentations 6203 to stop the adjusting frame 620 from moving up. When the hanger body is retracted onto the chair back 100, it is received within a hanger groove 1501 so that outlook of the chair back is smooth.

As shown in FIG. 1B, another the preferred embodiment of the present invention is provided with a adjusting frame 620 in which the pull resistant indentations 6203 are through holes, and the pull resistant block 6204 consists two pieces. As the adjusting frame 620 is pulled up to a predetermined maximum height, two tongues respectively of two pieces of the pull resistant block 6204 are inserted into the through holes to stop the adjusting frame 620 from moving up. Since the restricting force is equally supported by two pieces of the pull resistant block 6204, the adjusting frame 620 will not vibrate and the hanger body is therefore more stable.

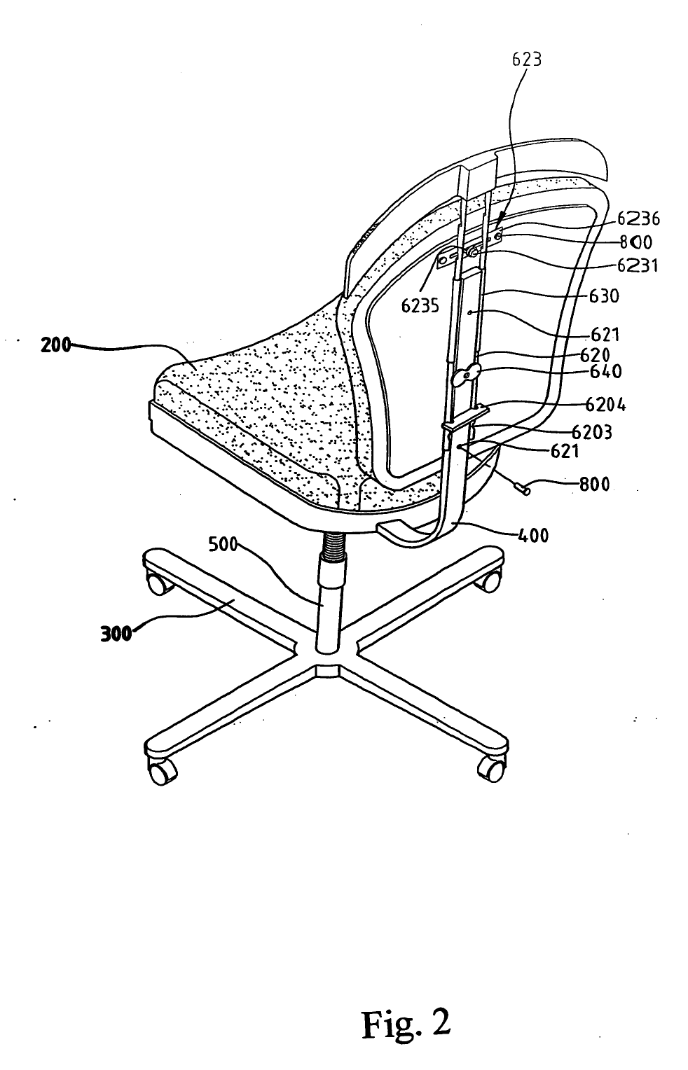

Referring to FIG. 2, a wheeled chair having a clothes hanger according to the present invention comprises a chair back 100, a chair seat 200 and a stand 300. The chair back 100 is connected to the chair seat 200 using a fixing frame 400. The rear side of the chair back is further provided with a clothes hanger 600 for hanging clothes.

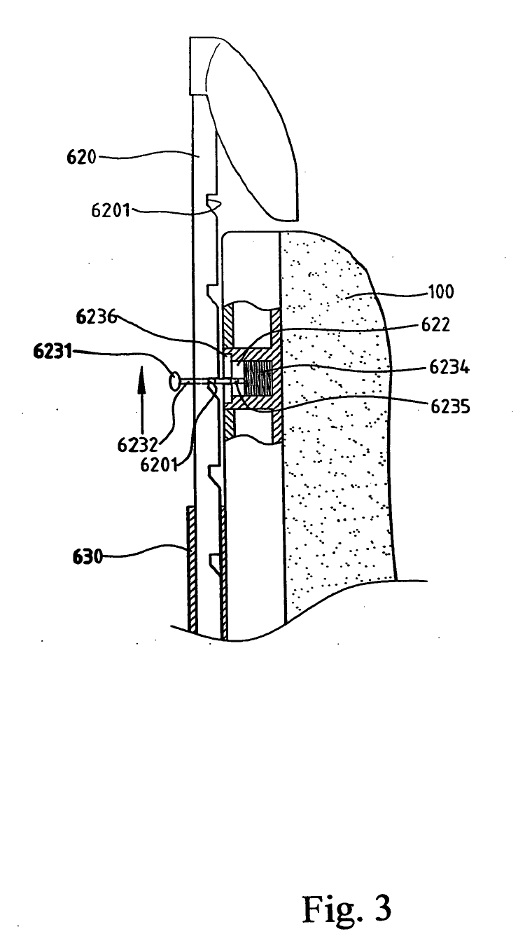

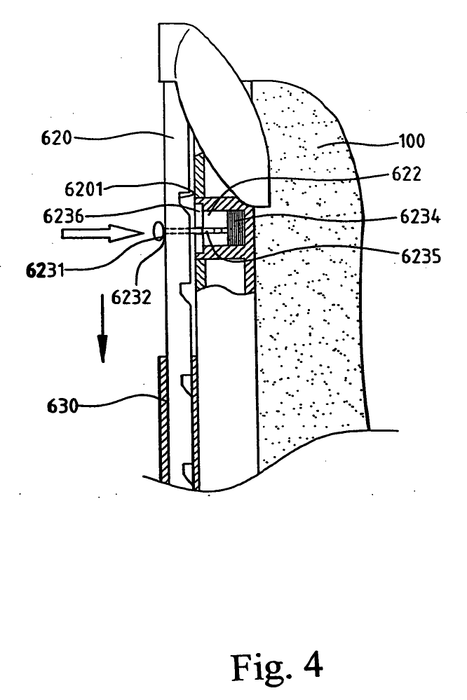

Referring to FIG. 3 and 4, to move the adjusting frame 620 upward, the adjusting frame 620 is pulled upward to a predetermined position where a pair of cushioning indentations 6201 are engaged with the pressing piece 6235 ejected by the spring 6234, achieving a stable configuration.

To move the adjusting frame 620 downward, the button 6231 on the tip of the tenon tongue 6232 of the pressing piece 6235 extending from the chair back 100 is pressed, so as to release the cushioning indentations 6201 of the adjusting frame 620 from the restriction as applied by the pressing piece 6235. The adjusting frame 620 is then pushed downward to a predetermined position where a pair of cushioning indentations 6201 are engaged with the pressing piece 6235 ejected by the spring 6234, achieving a stable configuration.

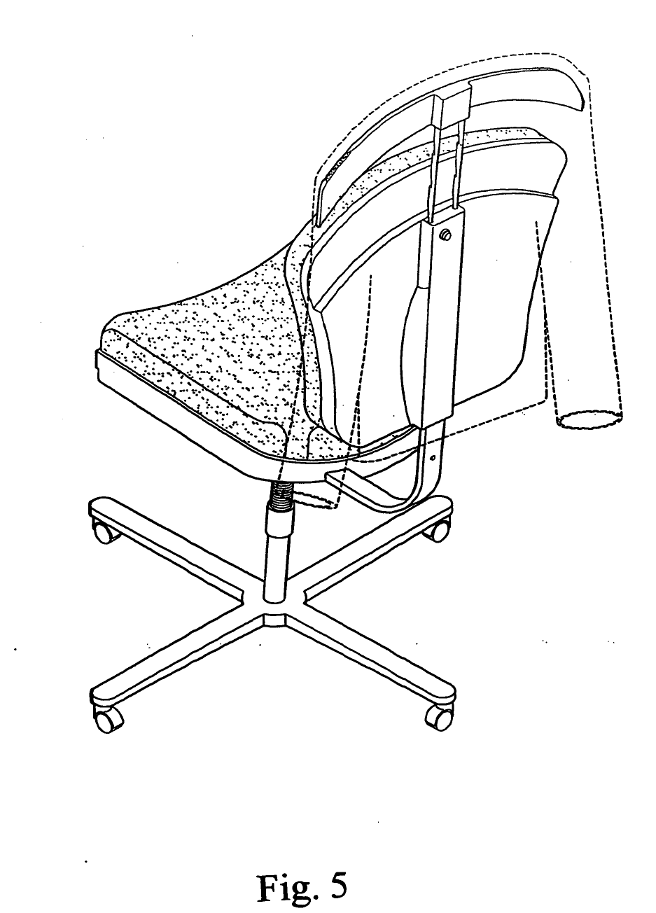

Referring to FIG. 5, is a perspective view of a wheeled chair having a clothes hanger according to the present invention.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

1. A wheeled chair having a clothes hanger comprising:
a chair back provided with a height-adjusting device, a cushion device and a clothes hanger for hanging clothes and adjusting the height of the clothes hanger;
a chair seat connected with the chair back using a fixing frame; and
a stand connected to the chair seat using a tubular axle.

2. The a wheeled chair having a clothes hanger of claim 1, wherein the fixing frame is L-shaped so that the back side of the chair is attached to the vertical section of the fixing frame.

3. The a wheeled chair having a clothes hanger of claim 1, wherein the fixing frame is provided with a plurality of screwed holes, the number of the screwed holes being odd.

4. The a wheeled chair having a clothes hanger of claim 1, wherein a right top lateral side and a left top lateral side of the fixing frame are each provided with a retaining base; wherein each of the retaining bases is provided with a through hole for receiving a corresponding arm of a U-shaped adjusting frame so that the adjusting frame is capable of moving vertically along the retaining bases.

5. The a wheeled chair having a clothes hanger of claim 1, wherein a bottom end of the fixing frame is provided with a cushioning butterfly plate.

6. The a wheeled chair having a clothes hanger of claim 5, wherein at least one pull resistant block is mounted under the cushioning butterfly plate.

7. The a wheeled chair having a clothes hanger of claim 1, wherein the cushion device comprises a button, a tenon tongue, a spring and a mounting box.

8. The a wheeled chair having a clothes hanger of claim 1, wherein the height-adjusting device includes a U-shaped adjusting frame.

9. The a wheeled chair having a clothes hanger of claim 8, wherein each side arm of the adjusting frame is provided with a plurality of cushioning indentations in the upper portion thereof.

10. The a wheeled chair having a clothes hanger of claim 8, wherein each side arm of the adjusting frame is provided with a plurality of stopping indentations in the lower portion thereof.

11. The a wheeled chair having a clothes hanger of claim 8, wherein each side arm of the adjusting frame is provided with a pull resistant retaining indentation at the bottom end thereof.

12. The a wheeled chair having a clothes hanger of claim 1, wherein the clothes hanger is a T-shaped body composed of a transverse bar attached to a bar mount that is locked on a top end of the U-shaped adjusting frame; wherein the transverse bar forms an arc and has two ends each provided with an anti-slip granular structure for preventing clothes from slipping off.

13. The a wheeled chair having a clothes hanger of claim 1, wherein the anti-slip granular structure is a granular anti-slip piece.

14. The a wheeled chair having a clothes hanger of claim 9, wherein the transverse bar is provided with a handle in a middle lower portion thereof.

15. The a wheeled chair having a clothes hanger of claim 1, wherein a rear side of the chair back is provided with a groove that is equal in length to the clothes hanger.
